(19) United States
(12) Patent Application Publication
(10) Pub. No.: US 2026/0093454 A1
(43) Pub. Date: Apr. 2, 2026

(54) FINE-GRAINED MIXED PRECISION FOR LARGE LANGUAGE MODEL INFERENCE

(71) Applicant: NVIDIA Corp., Santa Clara, CA (US)

(72) Inventors: Coleman Hooper, Berkeley, CA (US); Charbel Sakr, Milpitas, CA (US); Rangharajan Venkatesan, Sunnyvale, CA (US); Brucek Kurdo Khailany, Rollingwood, TX (US); Benjamin Andrew Keller, Oakland, CA (US)

(73) Assignee: NVIDIA Corp., Santa Clara, CA (US)

(21) Appl. No.: 18/984,358

(22) Filed: Dec. 17, 2024

Related U.S. Application Data
(60) Provisional application No. 63/700,350, filed on Sep. 27, 2024.

(51) Int. Cl. G06F 7/523

(52) U.S. Cl. CPC G06F 7/523

(57) ABSTRACT

Mechanisms that enable particular model parameters and activations in artificial intelligence models to be stored in low precision, and that enable operations involved in inference computation to be performed using low-precision data paths, by leveraging fine-grained mixed-precision quantization. The mechanisms may utilize a combination of hardware and software logic to determine the model parameters and activations to maintain at higher precision and to identify with low latency the activation vectors to be retained in higher precision, as well as the corresponding mixed-precision data path design to facilitate efficient mixed-precision inference.

### CROSS REFERENCE TO RELATED APPLICATIONS

This Application claims priority and benefit under 35 U.S.C. 119(e) to application Ser. No. 63/700,350, “Fine-Grained Mixed Precision for Efficient LLM Inference”, filed on Sep. 27, 2024, the contents of which are incorporated herein by reference in their entirety.

### BACKGROUND

Inference computations by Large Language Models (LLMs) may incur expensive energy consumption in computing systems. Energy may be conserved during inference by quantizing the model parameters to lower precision. However, it is challenging to quantize model parameters and activations to low precision without degrading the inference accuracy of the large language model.

Previous mechanisms for quantizing model parameters while preserving model accuracy transform the large language model weight matrices into a dense low-precision matrix and an unstructured sparse high-precision matrix. The high-precision matrix is used to accurately store numerical outliers and highly sensitive values. These conventional mechanisms may achieve high accuracy with low memory consumption for weight quantization, but are not readily applied for activation quantization. These conventional mechanisms also do not support the utilization of low-precision hardware data paths.

Another conventional mechanism to conserve energy during large language model inference utilizes structured mixed precision. In this approach a fixed block of the matrix is maintained in higher precision, and the remainder of the matrix is quantized to a lower precision. This mechanism may fail to adapt to the unstructured nature of important (relatively high inference impact) values in weights and activations.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an embodiment of a mixed-precision quantization mechanism.

FIG. 2 depicts an exemplary perplexity evaluation for a mixed-precision quantization mechanism.

FIG. 3A-FIG. 3C depict aspects of an embodiment of hardware logic to compute vector multiply-accumulate operations across multiple vector lanes in parallel.

FIG. 4A-FIG. 4B depict aspects of an embodiment of a mixed-precision activation quantization unit.

FIG. 5A-FIG. 5B depict aspects of another embodiment of a mixed-precision activation quantization unit.

FIG. 6 depicts an embodiment of a multi-lane vector-multiply-accumulate unit for performing mixed-precision computation.

FIG. 7 depicts an exemplary tiling across multiple processing elements.

FIG. 8A-FIG. 8B depict embodiments for performing mixed-precision distillation.

### DETAILED DESCRIPTION

Reducing the precision with which model parameters (e.g., weights) and activations are stored as well as performing computation using low-precision data paths may reduce latency and energy consumption for large language models, generative artificial intelligence models, and other artificial intelligence models. Herein, the terms “low precision” and “high precision” should be understood to be relative terms. In other words, “low precision” is a machine data format representing a datum with fewer bits than does a pre-quantization “high precision” format for the same datum.

The mechanisms disclosed herein may enable a majority of model parameters and activations to be stored in low precision, as well as for the majority of operations involved in inference computation to be performed using low-precision data paths, by leveraging fine-grained mixed-precision quantization. The disclosed mechanisms may utilize a combination of inventive hardware and software logic to determine the model parameters and activations to maintain at higher precision and to identify with low latency the activation vectors to be retained in higher precision, as well as the corresponding mixed-precision data path design to facilitate efficient mixed-precision inference.

The disclosed fine-grained mixed-precision mechanisms adapt to unstructured sensitive values in both weights and activations and enable a majority of inference computation to be performed using low precision data paths.

In addition to identifying the vectors to retain at higher precision during inference operations, the disclosed mechanisms may improve inference accuracy when weights are quantized to mixed precision.

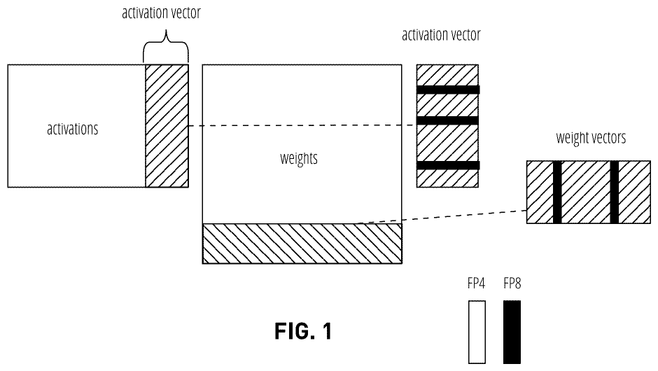

FIG. 1 depicts aspects of a fine-grained mixed-precision mechanism for weight and activation quantization at 1D block granularity. The example in FIG. 1 and embodiments depicted herein utilize FP4 and FP8 quantization (see below), but the disclosed mechanisms are more generally applicable to any mix of quantizations. The mechanism may be applied in the linear layers of an artificial intelligence model where a weight matrix W and activation matrix X are multiplied in order to compute the output Y. For both weights (W) and activations (X), the majority of weight and activation vectors are quantized to low precision while a small portion of vectors are preserved in higher precision to retain inference accuracy.

FP4 data quantization refers to the use of 4-bit floating-point representations to approximate values in computations. This type of quantization may be used in machine learning and neural networks to reduce the computational load, energy consumption, and memory usage. An FP4 number typically comprises a 3-bit mantissa and a 1-bit exponent, although configurations can vary.

FP8 data quantization involves using 8-bit floating-point numbers to represent values in computational tasks. FP8 may provide a middle ground between high-precision formats like FP16 or FP32 and more compact representations like FP4.

An FP8 number typically comprises one sign bit, a few exponent bits, and the remaining bits as the mantissa. Two common FP8 formats are E4M3, comprising a 1-bit sign, 4-bit exponent, and 3-bit mantissa, and E5M2, comprising a 1-bit sign, 5-bit exponent, and 2-bit mantissa.

1D block granularity refers to the division of weight and activation tensors into one-dimensional blocks for processing. Weight matrices and/or activations may partitioned into linear (1D) segments (vectors) for processing. Each partition forms a contiguous portion of the whole that may be processed independently of the other portions. Utilizing 1D blocks facilitates the balanced distributed of computations across processing units. It may help ensure that each processing element of the computing system receives an approximately equal portion of the task, thereby helping to optimize resource utilization. A 1D block granularity facilitates the scaling of application workloads across multiple processing elements thereby enabling a finer and more efficient divisions of tasks.

The vectors for both weights and activations which lead to the greatest perturbation in the output when quantized in lower precision are selected. A global cutoff point (threshold) may be configured for tensors of the entire model. This enables the preservation of a different proportion of sensitive vectors for particular layers that exhibit a greater or lesser impact on the final model precision loss.

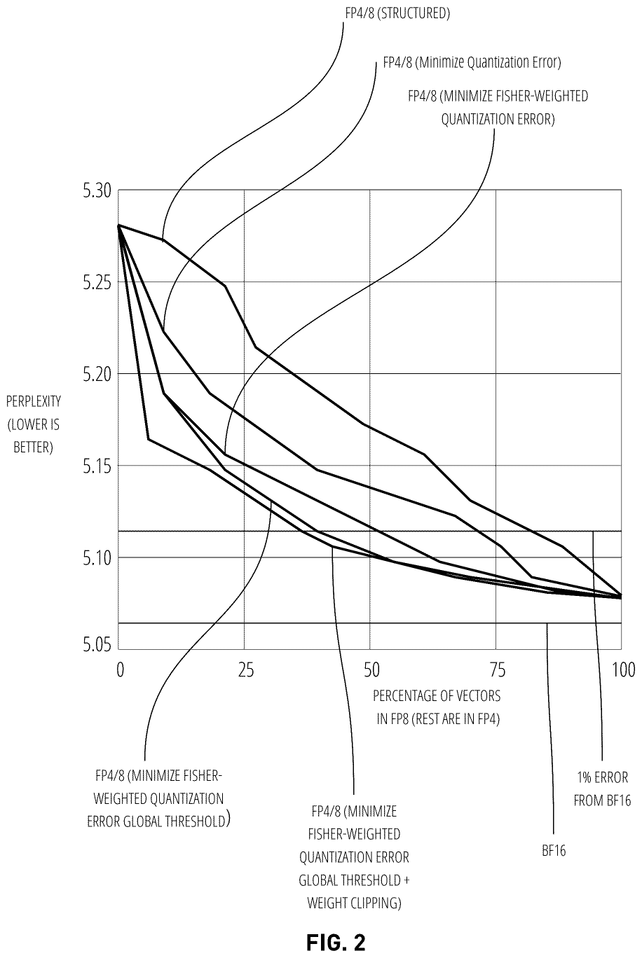

FIG. 2 depicts a perplexity evaluation for a mixed-precision approach with different portions of the weights and activations in low/high precision (e.g., FP4/FP8; the disclosed mechanisms generalize to different choices of low and high precision number formats). FIG. 2 depicts efficiencies of the disclosed mechanisms over baselines that do not incorporate sensitivity information. The FP4 data type may comprise micro-scaling metadata along with per-element data. Micro-scaling refers to applying a separate scale factor per 1-dimensional vector, where the vector size is on an order of less than or about 100 elements. A Fisher-weighted quantization approach may outperform naïve structured mixed-precision and quantization error minimizing mixed-precision baselines. Further perplexity benefits may be obtained with the utilization of global thresholding and Fisher-weighted clipping.

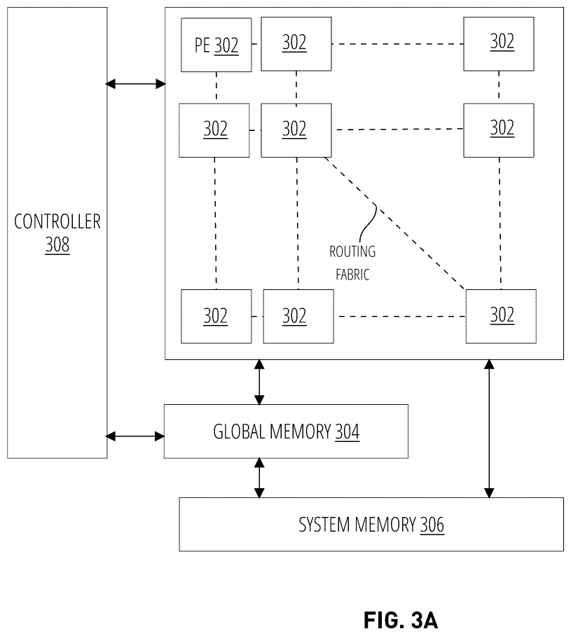

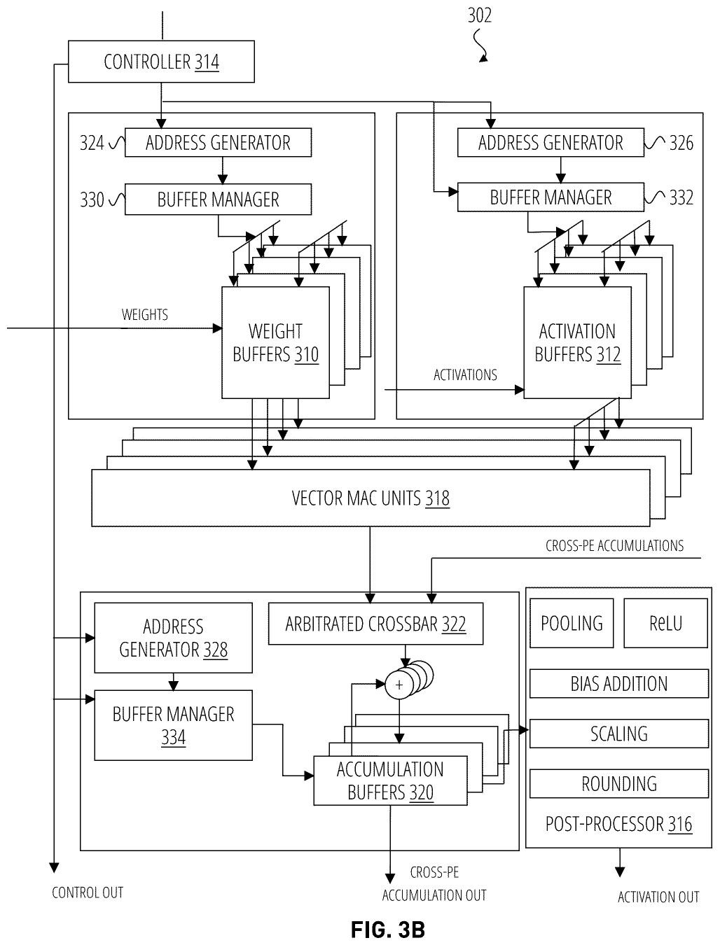

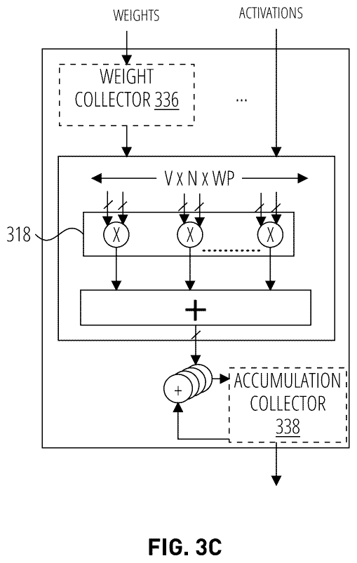

Particular hardware logic for quantizing activations to mixed-precision during inference may be utilized to obtain the energy and throughput benefits of fine-grained mixed-precision quantization. The hardware logic may comprise low-precision data paths for the majority of such computations. FIG. 3A-FIG. 3C depict aspects of one such embodiment of hardware logic to compute vector multiply-accumulate operations across multiple vectorized data lanes in parallel.

FIG. 3A depicts a scalable neural network processor in one embodiment. Weights for a deep neural network are tiled spatially across processing elements 302 via a routing fabric. The processing elements 302 may be co-located on a same die or chip, or on different die or chips. “Weights” refers to values with which activations are multiplied to increase or decrease the impact of the activation values in an activation function. Herein the terms “die” and “chip” are used interchangeably. The scalable neural network processor may be implemented by multiple chips in a single package/device/printed circuit board, or across multiple packages/devices/printed circuit boards.

Deep neural network applications and workloads may differ significantly in their computational resource requirements and power consumption. For example, typical data center inference applications such as image recognition may prioritize performance and scalability at low latency and may be willing to sacrifice classification accuracy, while inference for autonomous driving workloads may prioritize energy efficiency within real-time constraints while maintaining the best achievable network accuracy. Because application-specific inference accelerators can provide significant performance and power advantages compared to general-purpose solutions, it may be advantageous to enable custom solutions on a common architecture for different target markets and applications.

The processing system may further comprise a global memory 304, system memory 306, and a controller 308 (e.g., an open-source RISC-V processor). The processing elements 302 may be configured to communicate via a router (not depicted), which may be a central router or a router with logic distributed among the processing elements 302.

The system may be configured to distribute the weight values and the activation values among the processing elements 302 spatially and temporally (over time). The global memory 304 may function as a second-level buffer for the activation values during computation. “Second-level buffer” refers a memory where values are stored and retrieved from when the values are needed for computation but are not available in a first-level memory, e.g., the weight buffer 310 or activation buffer 312 of a processing element 302. The distribution of weights and activations during computation may be carried out by the controller 308. The controller 308 or local controllers 314 of any of the processing elements 302 may be configured by instructions stored in a memory to carry out various data flows described below. A system, processor, or controller configured in such a manner may conveniently be referred to herein as “logic”. The particular location of such logic in the system is a design choice. The memory storing such instructions may be any of the memories depicted in the figures, or a different memory not depicted.

Logic for mixed-precision quantization may in one embodiment utilize a) a post-processor 316 that quantizes activations to mixed-precision efficiently during deep learning model inference; b) data paths that support fine-grained mixed-precision; and c) spatial and/or temporal tiling of deep learning workloads according to the precisions of different vectors in weights and activations.

Referring to FIG. 3A, an embodiment of a processing element 302 may comprise a plurality of vector multiply-accumulate units 318, a weight buffer 310, and an activation buffer 312. The aforementioned router (not depicted) provides weights and activations to the processing element 302. The weight buffer 310 receives and stores weight values and the activation buffer 312 receives and stores activation values of a deep learning training or inference workload. Updated activations are computed in the processing element 302 by applying an activation function, also sometimes called a ‘transfer function’. Activations may be simple binary values (e.g., “1” or “0” representing “ON” or “OFF”) or they may take on a range of values for some activation functions. The vector multiply-accumulate units 318 combine, in parallel, the weight values and the activation values from the weight buffer 310 and activation buffer 312 respectively, to generate partial sums.

The activation buffer 312 may, in one embodiment, be implemented as a dual-ported SRAM to receive activation values from the global memory 304, system memory 306, or from other (e.g., adjacent) processing elements, via the router or other interconnect. The router may be a component of a distributed network-on-a-chip router that in one embodiment comprises a serializer/de-serializer, packetizer, arbitrator, Advanced eXtensible Interface (AXI), and other components known in the art. The router may also be a centralized routing component for the processing element 302, or a combination of centralized and distributed routing logic.

The activation buffers may comprise output ports that are IAP×V bits wide and operated such that a same activation vector is provided in parallel to N vector multiply-accumulate units 318. The setting IAP is an activation value precision that may be configurable at the controller 314 and/or controller 308. The parameter V is a number of multiplications and additions that the vector multiply-accumulate units 318 will perform per clock cycle. The number N of the vector multiply-accumulate units 318 that may be activated for a given data flow may be configurable at the controller 314 and/or controller 308. The values of V and N may be adjusted for more or less parallelism and reuse of weights, for example.

The weight buffer 310 may, in one embodiment, be implemented as a single-ported SRAM storing weigh values. The weight values used by the vector multiply-accumulate units 318 may be “weight-stationary”, meaning they are not updated each clock cycle, but instead are updated only after the output activation values are computed for a particular layer of the deep neural network.

The weight buffers 310 may comprise output ports that are WP×N×V bits wide, where WP is a configurable weight precision. In a given cycle, the weight buffers 310 may supply via their output ports different weight vectors to different ones of the vector multiply-accumulate units 318.

The processing element 302 further comprises a controller 308, accumulation memory buffers 320, and a post-processor 316. Output activations computed by the vector multiply-accumulate units 318 are stored in the accumulation memory buffer 320, which may comprise one or more SRAM devices. The vector multiply-accumulate units 318 may interact with the accumulation memory buffers 320 via a communication fabric such as an arbitrated crossbar 322 switch. The output activations computed by the processing element may be communicated (e.g., via the router) to other processing elements for further processing (e.g., by downstream layers of a neural network model).

The processing element 302 may perform operations of convolutional and fully-connected layers of a deep neural network model efficiently, including multiply-accumulate, truncation (rounding), scaling, bias addition, ReLU, and pooling (these last five may be implemented in the post-processor 316). The vector multiply-accumulate units 318 may operate on the same inputs using different filters. In one embodiment, each of the vector multiply-accumulate units 318 performs an eight-input-channel dot product and accumulates the result into the accumulation memory buffers 320 on each clock cycle. The weights stored in the weight buffer 310 may may remain unchanged until an entire computation of output activations completes. The processing element 302 may read the input activations in the activation buffer 312, perform the multiply-accumulate operations, and write output activations to the accumulation memory buffers 320 on a per-clock cycle basis. The frequency at which the weight buffer 310 is accessed depend on input activation matrix dimensions and the number of filters utilized.

Multiply-accumulate units may be referred to herein by their acronym, MAC or MAC unit. A MAC unit carries out computations of the form a<−a+(b*c). A vector MAC unit computes the product of two vectors using an array of multipliers, then performs a reduction operation by adding all the outputs of multipliers to produce a partial sum, which is then added to an accumulated value. The vector multiply-accumulate units 318 may compute a portion of a wide dot-product-accumulate as a partial result and forward the partial result to neighboring processing elements. A dot product is the sum of the products of the corresponding entries of the two sequences (vectors) of numbers.

Partial sums computed by the N vector multiply-accumulate units 318 may be packed into vectors of width AP×N and stored in the accumulation memory buffers 320. From there, they may be communicated either directly to another processing element for cross-processing element reduction or to the post-processor 316 to compute final output activations. The post-processor 316 may provide not only scaling and quantization but also ReLU and pooling operations to enable layer fusion. Partial results computed in the processing element 302 may be transformed into a final result by the post-processor 316 and communicated to the global memory 304 and/or system memory 306. The global memory 304 may function as a staging area for the final multiply-accumulate results that are communicated between layers of a deep neural network model.

The controller 308 may distribute the weight values and activation values among the processing elements and may utilize the global memory 304 as a second-level storage for the activation values. The controller 308 may configure the systems to process layers of a deep neural network model spatially across the processing elements 302 according to input/output channel dimensions of the layers, and may configure the processing elements 302 temporally according to overall dimensions of the model inputs or outputs.

The activation buffers 312 may each have an operational size IA and the weight buffers 310 may each have an operational size W, with one or both of W and IA being configurable at the controller 314 and/or controller 308. Likewise the accumulation memory buffers 320 may have an operational size of A that is configurable at the controller 314 and/or controller 308. “Operational size” refers to a resource pool available for performing calculations during operation of a device, which may be less than the total or maximum size of the resource pool. The operational size may be configurable using registers or other settings (e.g., for higher performance or less power consumption).

Based on the configuration of N and V, parameters such as W, IA, and A may be adjusted to ensure the vector multiply-accumulate units 318 are optimally utilized during deep learning model workloads.

Various address generators managers 324, 326, 328 may be utilized with the weight buffers 310, activation buffers 312, and accumulation memory buffers 320, respectively. The address generators may generate an address every compute cycle that specify the location in the buffers to read or write values. The ordering of operations carried out by the vector multiply-accumulate units 318, and the ordering of stored results, may be controlled by these address generators, which may configurable to support temporal reuse of weights in the weight buffers 310, and/or MAC results in the accumulation memory buffers 320, across clock cycles for different types of deep learning data flows.

Various buffer managers 330, 332, 334 may be utilized with the weight buffers 310, activation buffers 312, and accumulation memory buffers 320, respectively. The buffer managers may be responsive to the controller 314 to set the availability of data to the vector multiply-accumulate units 318. The dimensions of the address generators and the granularity of data movement from the weight buffers 310 and the activation buffers 312 to the vector multiply-accumulate units 318 may in some embodiments be configurable at the controller 314 and/or controller 308.

A number N of the vector multiply-accumulate units 318 may be activated for a given data flow. Each vector multiply-accumulate unit 318 may perform V multiplications and additions per clock cycle. Thus, in every clock cycle, the processing element may multiply a weight vector of dimensions N×V with an input activation vector of size V, to generate a partial-sum vector of size N. In other words, each of the vector multiply-accumulate units 318 may perform a V-wide dot product calculation per clock cycle, with one or both of N and V being configurable at the controller 314 and/or controller 308.

Each of the vector multiply-accumulate units 318 may be supplied with weight values from a corresponding weight collector 336, e.g., a memory buffer. The weight collectors 336 may each comprise a configurable depth (e.g., number of distinct registers or addresses in a register file used by the vector multiply-accumulate units 318 during computations) of WD and a width V×WP (WP being the weight value precision). For the N vector multiply-accumulate units 318, a total weight collector width may therefore come to V×N×WP.

Each of the vector multiply-accumulate units 318 may supply a corresponding accumulation collector 338 comprising a configurable operational depth AD and width AP (AP being the precision of accumulated partial products). For the N vector multiply-accumulate units 318, a total accumulation collector width may come to N×AP. The V-wide dot products and N-sized partial-sum vector may thus be computed by each vector multiply accumulate vector multiply-accumulate unit 318 at mixed precision. Some or all of WD, WP, IAP, AD, and AP may be configurable by the controller 314 and/or controller 308.

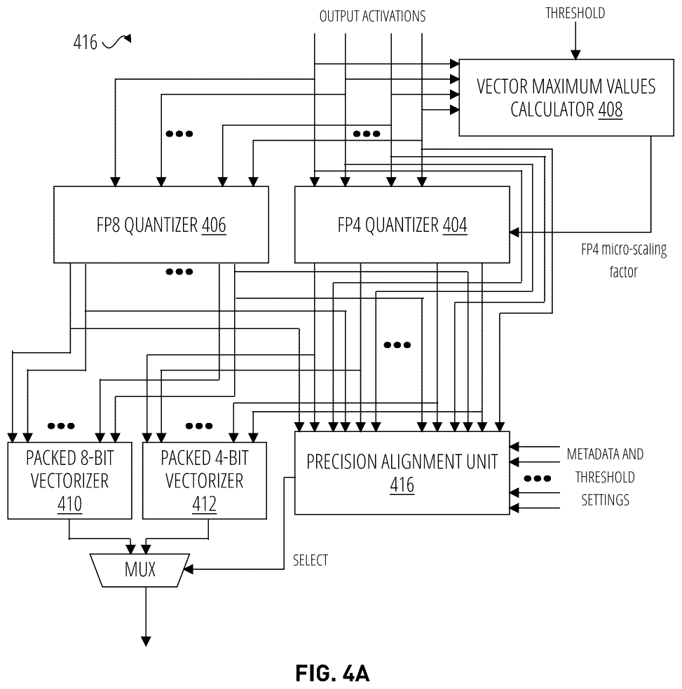

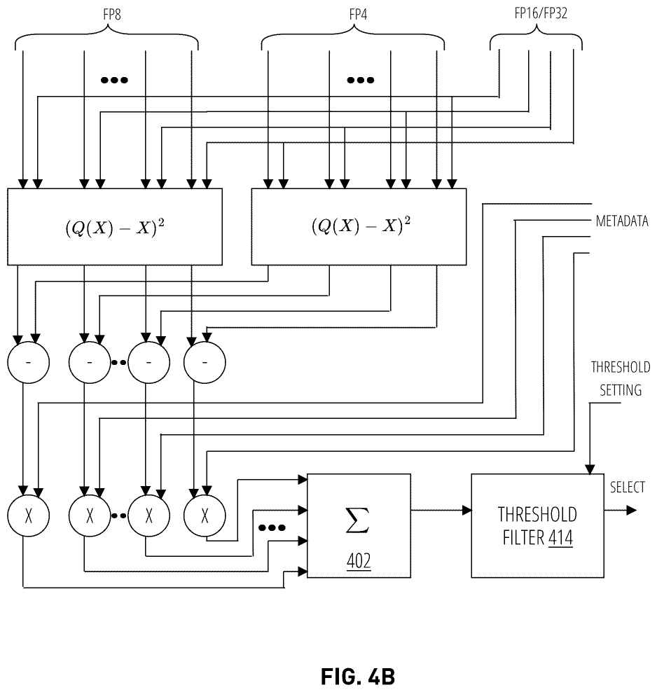

FIG. 4A and FIG. 4B depict an embodiment of a mixed-precision activation quantization unit. The mixed-precision activation quantization may be implemented by the post-processor 316 in one embodiment, to process output activation vectors of a processing element 302 before writing them out to memory, e.g., global memory 304 or system memory 306. The mixed-precision activation quantization unit inputs a high-precision output activation vector and the average Fisher information per-input channel as metadata, and transforms these inputs into a sensitivity-weighted sum (vector adder 402) of the quantization error for the output activation vector.

The output activation vector is quantized to FP4 (by FP4 quantizer 404) and FP8 (by FP8 quantizer 406). The FP4 quantization may be applied selectively to output activations. A scaling factor for the FP4 quantization may be determined by a maximum values calculator 408, where the maximum valued element of a vector may determine the scaling factor to apply to the vector. The quantized activations may be packed into vectors (packed 8-bit vectorizer 410 and packed 4-bit vectorizer 412). One of the packed vectors is selected (threshold filter 414) as the final output to global memory 304 or system memory 306 by a precision alignment unit 416 based on whether or not the sensitivity-weighted sum of the quantization error exceeds a configured threshold for maintaining the vector in higher precision. Weight and/or activation quantization may be carried out at a 1D block granularity.

The precision alignment unit 416 may compute a vector of quantization errors (Q(X)−X)₂ for each of the FP8 and FP4 quantized activation vectors, where Q(X) (i.e., X_{q}) is the quantized activation tensor and X is the unquantized activation tensor. The two tensors may be subtracted from one another to generate a difference tensor that is multiplied by the per-channel Fisher information. A sum (vector adder 402) is performed over the elements of the Fisher-weighted tensor and applied to select (threshold filter 414) either the FP4 quantized activations or the FP8 quantized activations to the global memory 304 or system memory 306 for further utilization in the deep learning model training or inference.

The Fisher information provides a mechanism to measure an amount of information that an observable random variable carries about an unknown parameter upon which the probability depends. Diagonal elements of a Fisher matrix represent the variances of a score (e.g., the gradient of a log-likelihood function) given to each parameter. The diagonal elements of a Fisher matrix may provide insights into the precision of the estimation of individual parameters, e.g., the diagonal elements indicate how sensitive a likelihood or probability is to small changes in each parameter, conveying the amount of information each parameter comprises independently.

The vectors to maintain in higher precision are those for which perturbing values has a relatively higher impact on the final model output loss. For weight matrices, diagonal Fisher information may be utilized as a metric of per-parameter sensitivity, which is calculated over a sample dataset D using the gradients g for each sample. For example:

$${F}_{ii} = \frac{1}{\vert D \vert} {\sum }_{D ∈ d} {g}_{d , i}^{2}$$

For activation sensitivity, the Fisher information may also be utilized as a sensitivity metric (e.g., by applying the gradient for a single sample):

$${F}_{ii} = {g}_{i}^{2}$$

For activations, the average Fisher information for each channel may be utilized to estimate per-channel sensitivity. The error ΔY in the output Y due to quantization in the weights W (e.g., during trining) and activations X (e.g., at inference time) for a given layer may be expressed as follows, where the approximate equality assumes that the magnitude of the cross-error term is small relative to the norms of the weights W and activations X:

$$△ Y = ( X + △ X ) * ( W + △ W ) - X * W = X * △ W + △ X * W + △ X * △ W \approx X * △ W + △ X * W$$

Implementing this formulation may minimize the error in the output by independently minimizing the error in X and W. The sensitivity-weighted error in the output due to weight quantization and activation quantization may be expressed as follows:

$$weights : {\sum }_{i = 1}^{N} {F}_{ii}^{W} △ {W}_{i}^{2}$$

$$activations : {\sum }_{i = 1}^{n} avg ( {F}_{ic , i}^{X} ) △ {X}_{i}^{2}$$

The vectors to maintain in higher precision may be identified as those with the highest (e.g., exceeding some configured threshold) reduction in sensitivity-weighted error when maintained in higher precision. The increase in error for output Yᵢ when quantized in low precision rather than higher precision may be expressed as follows:

$${△}_{lp \to h p} {Y}_{i} = {△}_{lp} {Y}_{i} - {△}_{h p} {Y}_{i}$$

The increase in error E when a vector of size V is quantized in low precision rather than high precision may be expressed as:

$$E = {\sum }_{i = 1}^{V} {( {△}_{lp \to h p} {Y}_{i} )}^{2}$$

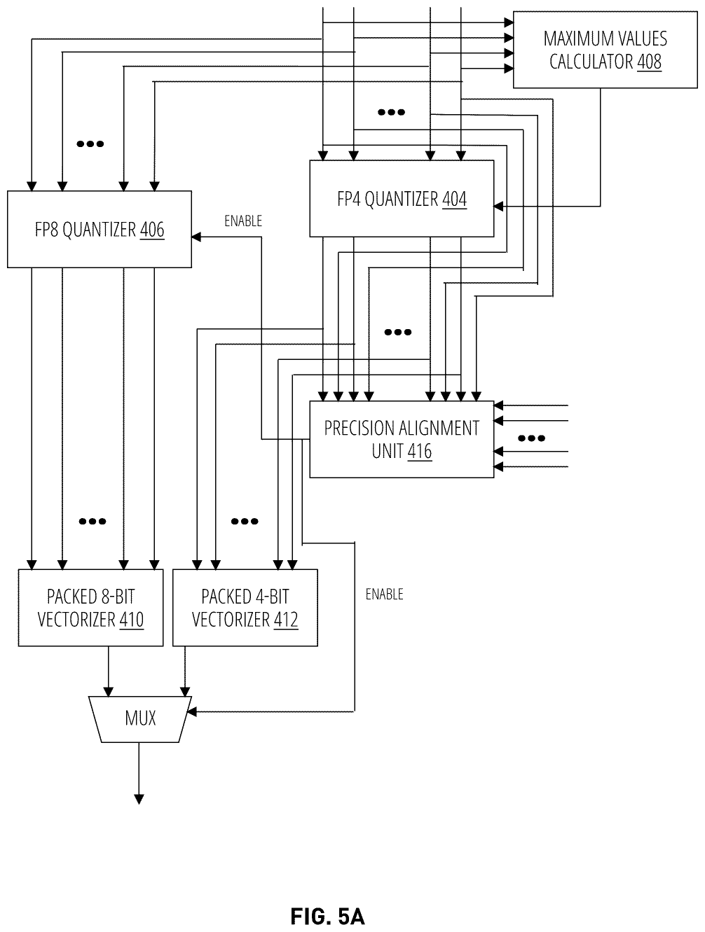

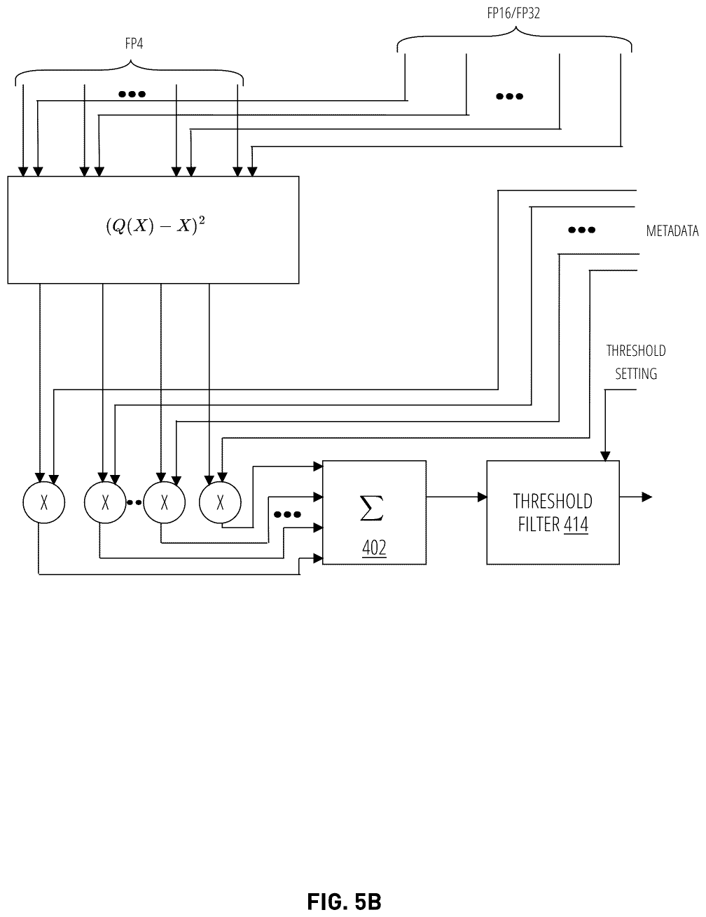

FIG. 5A and FIG. 5B depict an alternative embodiment of the mixed-precision activation quantization unit. In this alternative design, the unit quantizes the input activation vector to FP4 and computes the sensitivity-weighted sum of the quantization error at FP4 instead of the difference between the sensitivity-weighted error at FP4 and FP8. The activation vector is only quantized to FP8 (enable signal to FP8 quantizer 406 from the precision alignment unit 416) on condition that the sum is greater than the configured threshold for maintaining the vector in higher precision.

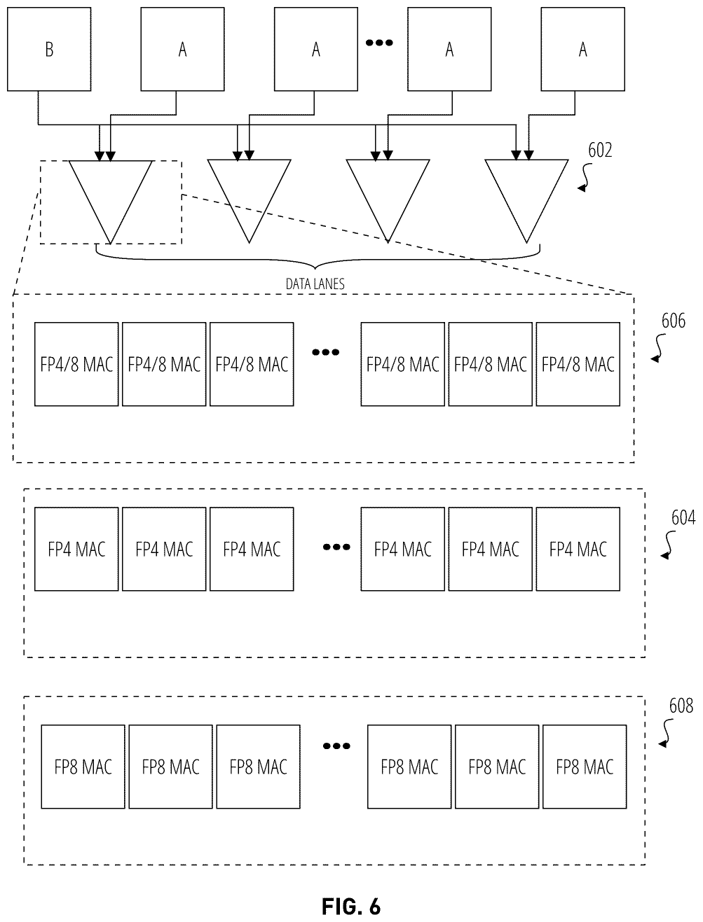

FIG. 6 depicts an embodiment of a multi-lane vector-multiply-accumulate unit (e.g., vector multiply-accumulate unit 318) that performs mixed-precision computation. The unit comprises multiple data lanes, each comprising FP4, FP8, and and mix of FP4 and FP8 dot-product computation units. The data path that is selected for performing for a particular operation within each data lane depends on the precisions of the two input tensors A (e.g., activations) and B (e.g., weights). The tensor A may be static (maintained in an unchanged state), and vectors from tensor B may be streamed in for serial processing one at a time and broadcast across the data lanes.

In a single clock cycle, the unit in the depicted example computes dot products in a number P (e.g., 16) of parallel data lanes 602, each configured to compute up to M (e.g., 32) FP8 dot-products or N (e.g., 64) FP4 or FP4 and FP8 dot-products. Each of the data lanes 602 comprises a plurality of data paths each comprising a plurality of multiply-accumulate units.

On condition that the vector from B is quantized to FP4, a dot-product (e.g., 64 bits wide) may be computed in each data lane, e.g., in data path 604, in either FP4 or a mixture of FP4 and FP8 (e.g., data path 606), depending on the precisions of the vectors from A.

On condition that the vector from B is quantized to FP8, a dot-product half as wide (e.g., 32 bits wide) may be computed in each data lane in either FP8 (e.g., data path 608) or a mixture of FP4 and FP8 (e.g., data path 606), depending on the precisions of the vectors from A. If additional bandwidth is available, 64-wide dot-products may be formed when the vector from A is FP4 and the vector from B is FP8.

Workload tiling (the assigning of chunks of weights and activations) may also be applied both within a single processing element and across and among processing elements. For example, to any particular processing element, sufficient elements of tensor B should be supplied in order to enable sufficient weight and/or activation reuse to meet bandwidth requirements BW (in bytes per clock cycle) for streaming vectors of tensor A into the system. Assuming a fixed width for tensor A (which is equal to the number of lanes), and assuming that both tensor A and tensor B comprises a mix of FP4 and FP8 quantized vectors partitioned at a 1D block granularity, the following expression represents a minimum reuse condition b to satisfy, where #A_{FP8} indicates a number of FP8 elements of A across N data lanes and #A_{FP4} indicates a number of FP4 elements of A across N data lanes:

$$b = ( 2 \times \# {A}_{FP 8} + \# {A}_{FP 4} ) * \frac{0.5}{BW}$$

This relationship may be utilized to determine a minimum tile size for vectors of B to supply to a processing element. The tile size may be increased from this minimum in some cases to improve reuse.

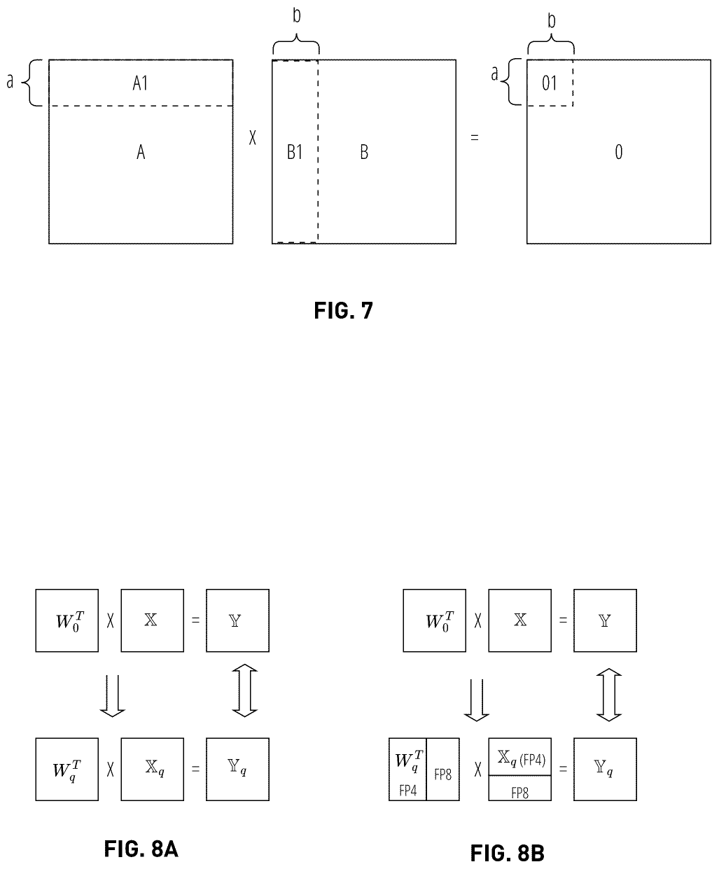

An additional challenge is balancing workload assignment across multiple processing elements given that the partitions of tensors A and B that are assigned to each may comprise a mix of FP4 and FP8 vectors. An example is depicted in FIG. 7.

The computation of a tile of outputs O may be assigned to each processing element, and a determination of the size of each output tile may be utilized to balance the work across the processing elements by setting the parameters a and b. The number of dot products to compute each cycle may be independent of the precision of the vectors in child tensor A1, assuming that parent tensor A is the tensor in the workload that is stationary.

The execution time for the workload depends on the ratio of FP4 and FP8 vectors in child tensor B1. Therefore it may be advantageous to set parameter b differently per-output tile in order to balance the workload across processing elements. After initially setting the tile sizes a and b to optimize for maximum reuse, it may be desirable to adjust the value of b for different tiles to balance latency.

Each column i in B may comprise an “effective width” (in terms of the latency to compute that particular column) represented by αᵢ=1+% FP8. This relationship holds because the column may take proportionately longer (than an FP4 quantized column) to compute depending on how many FP8 vectors it comprises. The “effective width” of each tile j may therefore equal to Σi αᵢ for all columns i in tile j.

A goal may be configured in the system to adjust the width of tiles in B in order to balance Σi αᵢ across all tiles. This goal may be formalized as follows: given a list of N numbers with fixed order, how may the list be partitioned into M sub-lists in order to minimize the maximum of the sums of each sub-list.

Additional orthogonal mechanisms may also be utilized to improve accuracy with low-precision quantized vectors, thereby enabling the quantization of a greater portion of vectors to FP4 with limited quantization error. One such mechanism involves the use of clipping to adjust the scaling factors during quantization in order to reduce the impact of large-magnitude outliers in skewing the quantization range. For example, a sensitivity-weighted approach may be utilized for fine-grained clipping to accurately quantize low-precision vectors. For a given vector with size V, an objective may be set to minimize the squared quantization error in X weighted by the diagonal Fisher information matrix elements Fᵢᵢ, and to select the scaling factor As which minimizes this objective:

$${min}_{s} {\sum }_{i = 1}^{V} {{F}_{ii} ( {△}_{s} {X}_{i} )}^{2}$$

For the FP4 datatype the fine-grained scaling factors may be restricted to FP8 values, and as such there are 128 possible values for As. In one embodiment, a brute-force search may be performed over possible values for As in order to identify the scaling factors which minimize the sensitivity-weighted quantization error.

The disclosed mechanisms additionally may include layer-wise distillation that doesn't utilize backpropagation for adapting each layer when quantized to mixed precision. This enhancement may implement Newton's algorithm

$${x}_{n + 1} ← {x}_{n} - \frac{{f}^{′} ( {x}_{n} )}{{f}^{′′} ( {x}_{n} )} ,$$

which does not utilize hyperparameters and demonstrates quadratic convergence.

FIG. 8A depicts an example of processing weights and activations into an output tensor during artificial intelligence training, where the weights are formatted in one precision type, e.g., FP4. FIG. 8B depicts another example of processing weights and activations into an output tensor during artificial intelligence training, where the weights are formatted in a mix of precision types, e.g., FP4 and FP8.

A goal may be configured in the system to minimize a distance between the golden (unperturbed) and corrupted (quantized) outputs: E[(Y−Y_{q})²], where Y=WX and Y_{q}=W_{q}X_{q}. Applying Newton's algorithm, the weight update is

$${W}_{q}^{T} ← {W}_{q}^{T} - {H}_{{W}_{q}}^{- 1} {▽}_{{W}_{q}} ,$$

where

$${H}_{{W}_{q}}^{- 1}$$

is the inverse of the Hessian of (Y−Y_{q})² with respect to W_{q} and is the gradient of (Y−Y_{q})² with respect to W_{q}. The layer-wise distillation approach is based on the weight update expressed in closed form as follows, where X̅_̅{̅q̅}̅ is the matrix X_{q} with each column divided by its own norm M:

$${H}_{W}^{- 1} {▽}_{W} = \frac{1}{M} {\overline{{X}_{q}} ( Y - {Y}_{q} )}^{T}$$

This update algorithm is practical to compute for deep learning model training and/or inference, and minimizes E[(y−y_{q})²] without utilizing backpropagation, thereby supporting layer-wise distillation in a single forward pass. Variants of a layer-wise distillation algorithm using this approach include:
Updating the entire weight matrix, with the weights quantized to a single precision (e.g., FP4);
Updating the entire weight matrix, with the weights quantized to mixed precision; and
Updating only the high-precision components of the weight matrix when the weights are quantized to mixed precision.

### LISTING OF DRAWING ELEMENTS

302 processing element
304 global memory
306 system memory
308 controller
310 weight buffer
312 activation buffer
314 controller
316 post-processor
318 vector multiply-accumulate unit
320 accumulation memory buffer
322 arbitrated crossbar
324 address generator
326 address generator
328 address generator
330 buffer manager
332 buffer manager
334 buffer manager
336 weight collector
338 accumulation collector
402 vector adder
404 FP4 quantizer
406 FP8 quantizer
408 maximum values calculator
410 packed 8-bit vectorizer
412 packed 4-bit vectorizer
414 threshold filter
416 precision alignment unit
602 data lanes
604 data path
606 data path
608 data path

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C. § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A process comprising:
quantizing a subset of vectors of a tensor, thereby forming quantized vectors;
generating Fisher values for the quantized vectors; and
based on an application of the Fisher values to the quantized vectors, selectively directing the quantized vector to a low-precision floating-point data path of a hardware processor.

2. The process of claim 1, wherein the low-precision floating-point data path comprises a mix of FP4-precision multiply-accumulate units and FP4-precision multiply-accumulate units.

3. The process of claim 1, wherein the low-precision floating-point data lane comprises only FP4-precision multiply-accumulate units.

4. The process of claim 1, wherein the low-precision floating-point data lane comprises only FP8-precision multiply-accumulate units.

5. The process of claim 1, wherein the Fisher values comprise variances of perturbation sensitivity scores for the quantized vectors.

6. The process of claim 1, wherein the tensor comprises a weight tensor or an activation tensor of an artificial intelligence model.

7. The process of claim 1, further comprising:
selectively directing vectors of the tensor that were not quantized to a high-precision data lane of the hardware processor.

8. A mixed-precision quantization circuit comprising:
a first quantizer configured to quantize inputs at a first precision to a first quantized vector;
a second quantizer configured to quantize the inputs at a second precision to a second quantized vector, the second precision different than the first precision; and
logic to select either the first quantized vector on the second quantized vector to an output based on a Fisher-scaled total quantization error difference between the first vector and the second vector.

9. The mixed-precision quantization circuit of claim 8, wherein the memory is a global memory for a plurality of processors.

10. The mixed-precision quantization circuit of claim 8, wherein the first quantizer is an FP4 quantizer and the second quantizer is an FP8 quantizer.

11. The mixed-precision quantization circuit of claim 8, wherein the logic to select either the first quantized vector on the second quantized vector is configured to determine whether the Fisher-scaled total quantization error difference exceeds a configured threshold for maintaining the vector in precision higher than FP8 precision.

12. The mixed-precision quantization circuit of claim 8, wherein the logic to select either the first quantized vector on the second quantized vector is configured to determine a vector of quantization errors (Q(X)−X)² for each of the quantized vectors, where Q(X) is the quantized vector and X is the corresponding unquantized inputs.

13. A mixed-precision quantization circuit comprising:
a first quantizer configured to quantize inputs at a first precision to a first quantized vector;
a second quantizer configured to quantize the inputs at a second precision to a second quantized vector, the second precision higher than the first precision; and
logic to selectively activate the second quantizer to produce the second quantized vector based on a Fisher-scaled total quantization error of the first vector.

14. The mixed-precision quantization circuit of claim 13, further comprising:
logic to select either the first quantized vector on the second quantized vector to an output based on the Fisher-scaled total quantization error of the first vector.

15. The mixed-precision quantization circuit of claim 13, wherein the first quantizer comprises an FP4 quantizer.

16. The mixed-precision quantization circuit of claim 13, wherein the second quantizer comprises an FP8 quantizer.

17. The mixed-precision quantization circuit of claim 13, further comprising:
a plurality of FP8-precision multiply-accumulate units; and
a plurality of FP4-precision multiply-accumulate units.

18. The mixed-precision quantization circuit of claim 13, wherein the Fisher-scaled total quantization error is determined from variances of perturbation sensitivity scores for the first quantize vector.

19. The mixed-precision quantization circuit of claim 13, wherein one of the inputs comprise an activation tensor of an artificial intelligence model.

20. The mixed-precision quantization circuit of claim 13, configured to selectively direct vectors of the inputs that were not quantized to a high-precision data lane.
